(19) United States
(12) Patent Application Publication
(10) Pub. No.: US 2012/0105404 A1
(43) Pub. Date: May 3, 2012

(54) DISPLAY DEVICE WITH LIGHT SENSORS

(75) Inventors: Toshimitsu Gotoh, Osaka (JP); Atsushi Okada, Osaka (JP); Kouji Kumada, Osaka (JP); Masaaki Nishio, Osaka (JP)

(73) Assignee: SHARP KABUSHIKI KAISHA, Osaka (JP)

(21) Appl. No.: 13/379,256

(22) PCT Filed: Feb. 26, 2010
(86) PCT No.: PCT/JP10/53050

§ 371 Date: Dec. 19, 2011

(30) Foreign Application Priority Data
Jun. 24, 2009 (JP) 2009-149310

(51) Int. Cl. G09G 5/00

(52) U.S. Cl. 345/207

(57) ABSTRACT

A recognition processing unit (22) performs recognition processing on a scan image based on a signal read from a light sensor (2) and outputs coordinate data (Co) indicating the position of an object to be detected. A mode control unit (24) determines a normal mode in which the recognition processing unit (22) is operated or a standby mode in which the operation of the recognition processing unit (22) is stopped. A thinned image memory (25) stores a thinned image when the normal mode is switched to the standby mode. The mode control unit (24) switches the standby mode to the normal mode when a newly supplied thinned image changes from the stored thinned image by a prescribed amount or more. Thus, it is possible to rapidly leave the standby mode and quickly detect the contact position.

### TECHNICAL FIELD

The present invention relates to a display device, especially to a display device having a plurality of light sensors in a display panel.

### BACKGROUND ART

In recent years, electronic devices that can be operated by touching the screen with a finger, a pen or the like have been in widespread use. As a method of detecting a position within the display screen where a contact was made, a method of forming a plurality of light sensors in the display panel, and detecting a silhouette or a reflected image, which is generated when a finger or the like approaches the screen, using the light sensors is known. Moreover, also known is a method of forming an infrared backlight that emits infrared light in a display device, and detecting a reflected image created by the infrared light using the light sensors, in order to detect a contact position with high accuracy regardless of display data.

Other than an infrared backlight, such a display device equipped with light sensors includes an A/D converter, which converts a signal read from the light sensors to a digital signal, a recognition processing unit, which finds a contact position based on the obtained digital signal, and the like. Therefore, a display device equipped with light sensors has a problem that the power consumption is larger than a display device equipped with no light sensors.

Here, considered as one of the methods to reduce the power consumption is a method of having a normal mode and a standby mode in a display device equipped with light sensors, and stopping the operation of circuits, slowing down the operation speed of circuits, or the like when in the standby mode. Patent Document 1 discloses a display device equipped with a light sensing unit and a contact sensing unit in a display panel that, based on an output signal from the contact sensing unit, makes a shift to the standby mode when it was determined that no contact was made for a prescribed time period, and makes a shift to the normal mode when it was determined that a contact was made.

### RELATED ART DOCUMENTS

### Patent Documents

Patent Document 1: Japanese Patent Application Laid-Open Publication No. 2006-201763

### SUMMARY OF THE INVENTION

### Problems to be Solved by the Invention

However, in the display device of Patent Document 1, a shift from the standby mode to the normal mode is made when a finger is sensed by the contact sensing unit. In other words, even when a finger approaches the screen, this display device remains in the standby mode until the finger contacts the screen. Therefore, because a timing of a transition from the standby mode to the normal mode is slow, this display device has a problem that it takes time to be released from the standby mode and detect the contact position.

Thus, an object of the present invention is to provide a display device equipped with light sensors that is capable of being rapidly released from of the standby mode and quickly detecting the contact position.

### Means for Solving the Problems

A first aspect of the present invention is a display device equipped with a plurality of light sensors, including:

a display panel including a plurality of pixel circuits and a plurality of light sensors arranged two dimensionally;

a drive circuit that performs an operation of writing a signal in accordance with display data to the pixel circuits, and performs an operation of reading a signal that corresponds to an amount of received light from the light sensors;

a recognition processing unit that performs a recognition processing on a recognition target image that is generated based on the signal read from the light sensors, and outputs coordinate data indicating a position of an object of detection;

a mode control unit that determines whether in a normal mode or in a standby mode, the mode control unit causing the recognition processing unit to operate in the normal mode, and causing the recognition processing unit to cease operating in the standby mode; and

an image storing unit that stores a comparison target image that is generated based on a signal read from the light sensors when the normal mode is switched to the standby mode,

wherein the mode control unit switches the standby mode to the normal mode when a newly supplied comparison target image changes from the comparison target image stored in the image storing unit by a prescribed amount or more.

A second aspect of the present invention is the first aspect of the present invention,

wherein the mode control unit compares the comparison target image stored in the image storing unit with the newly supplied comparison target image pixel by pixel, and switches the standby mode to the normal mode when the number of pixels at which a difference in pixel value is equal to or greater than a first threshold value is equal to or exceeds a second threshold value.

A third aspect of the present invention is the second aspect of the present invention,

wherein at least one of the first and second threshold values is stored in a register that is capable of setting the value from outside.

A fourth aspect of the present invention is the first aspect of the present invention, wherein the mode control unit switches the normal mode to the standby mode when a state that the coordinate data is not output continues for a prescribed time period.

A fifth aspect of the present invention is the fourth aspect of the present invention,

wherein, immediately after the standby mode is switched to the normal mode, the mode control unit switches the normal mode to the standby mode when a state that said coordinate data is not output continues for a shorter period of time compared to when the normal mode has been continuously in effect.

A sixth aspect of the present invention is the first aspect of the present invention,

wherein the comparison target image includes a smaller number of pixels than the recognition target image.

A seventh aspect of the present invention is the sixth aspect of the present invention,

wherein the comparison target image is an image generated by partially extracting pixel values from the recognition target image.

An eighth aspect of the present invention is the seventh aspect of the present invention,

wherein an extraction range for the comparison target image is stored in a register that is capable of setting a value from outside.

A ninth aspect of the present invention is the seventh aspect of the present invention,

wherein, according to a result determined by the mode control unit, in the standby mode, the drive circuit reads a smaller amount of signals from the light sensors than when in the normal mode.

A tenth aspect of the present invention is the seventh aspect of the present invention, further including an A/D converter that converts a signal read from the light sensors to a digital value,

wherein, according to a result determined by the mode control unit, the A/D converter performs a conversion to a digital value less frequently in the standby mode than in the normal mode.

An eleventh aspect of the present invention is the first aspect of the present invention, further including an infrared backlight that emits infrared light,

wherein the mode control unit turns off the infrared backlight in the standby mode.

A twelfth aspect of the present invention is a method of controlling a display device that is equipped with a display panel including a plurality of pixel circuits and a plurality of light sensors arranged two dimensionally; and a recognition processing unit that performs a recognition processing on a recognition target image based on a signal read from the light sensors, and outputs coordinate data indicating a position of a detection target object, the method including:

writing a signal in accordance with display data to the pixel circuits,

reading from the light sensors a signal corresponding to an amount of received light,

determining whether in a normal mode or in a standby mode,

operating the recognition processing unit in the normal mode, and stopping an operation of the recognition processing unit in the standby mode, and

storing a comparison target image based on a signal read from the light sensors when the normal mode is switched to the standby mode,

wherein the step of determining the mode causes the standby mode to be switched to the normal mode when a newly supplied comparison target image changes from the stored comparison target image by a prescribed amount or more.

### Effects of the Invention

According to the first or the twelfth aspect of the present invention, the normal mode or the standby mode is determined, and the operation of the recognition processing unit is stopped in the standby mode, and therefore, the power consumption of the display device can be reduced. Furthermore, the normal mode will resume when a comparison target image, which is based on a signal read from light sensors, changes by a prescribed amount or more since the switch to the standby mode was made, and therefore, the normal mode can be resumed before the detection target object contacts the screen. Accordingly, it is possible to rapidly leave the standby mode and quickly detect the contact position.

According to the second aspect of the present invention, two comparison target images are compared pixel by pixel, and the normal mode is resumed when the number of pixels for which a difference in pixel values is equal to or more than a first threshold value is equal to or exceeds a second threshold value, and therefore, the normal mode can be resumed before the detection target object contacts the screen. Accordingly, it is possible to rapidly leave the standby mode and quickly detect the contact position.

According to the third aspect of the present invention, a threshold value to be used for a mode determination processing is stored in a register, and therefore, the condition of the mode determination processing can be adjusted in accordance with a usage mode or the like, and a suitable mode determination processing can be performed.

According to the fourth aspect of the present invention, the standby mode becomes in effect when a state where no coordinate data is output continues, and therefore, it is possible to enter the standby mode to stop the recognition processing unit when it is not necessary to perform the recognition processing, thereby reducing the power consumption of the display device.

According to the fifth aspect of the present invention, immediately after the mode is switched to the normal mode, a shift to the standby mode is made when a state where no coordinate data is output continues for a shorter period of time, and therefore, it is possible to resume the standby mode within a short period of time to stop the recognition processing unit when it is not necessary to perform the resumed recognition processing, and to reduce the power consumption of the display device more effectively.

According to the sixth aspect of the present invention, a comparison target image that has a smaller number of pixels than a recognition target image is used to perform a mode determination processing, and therefore, it is possible to reduce the amount of memory and the amount of computing necessary for the mode determination processing.

According to the seventh aspect of the present invention, an image generated by partially extracting pixel values from a recognition target image becomes a comparison target image, and therefore, it is possible to easily generate a comparison target image without performing an average value computation processing or the like.

According to the eighth aspect of the present invention, the extraction range for the comparison target image is stored in a register, and therefore, it is possible to extract the comparison target image from a preferable position in accordance with a usage mode or the like, and to perform a suitable mode determination processing.

According to the ninth aspect of the present invention, the operation speed of the drive circuit is slowed down in the standby mode, and therefore, it is possible to reduce the power consumption of the display device while generating a comparison target image necessary for the mode determination processing.

According to the tenth aspect of the present invention, the operation speed of the A/D converter is slowed down in the standby mode, and therefore, it is possible to reduce the power consumption of the display device while generating a comparison target image necessary for the mode determination processing.

According to the eleventh aspect of the present invention, the infrared backlight is turned off in the standby mode, and therefore, it is possible to reduce the power consumption of the display device.

### BRIEF DESCRIPTION OF THE DRAWINGS

FIG. 1 is a block diagram showing the configuration of a liquid crystal display device according to an embodiment of the present invention.

FIG. 2 is a block diagram showing the detailed configuration of a liquid crystal panel of the liquid crystal display device shown in FIG. 1.

FIG. 3 is a timing chart of the liquid crystal display device shown in FIG. 1.

FIG. 4 is a diagram showing a cross-section of a liquid crystal panel and the arrangement position of a backlight of the liquid crystal display device shown in FIG. 1.

FIG. 5A is a diagram showing a principle of a method of detecting an image in the liquid crystal display device shown in FIG. 1.

FIG. 5B is a diagram showing a principle of a method of detecting a reflected image in the liquid crystal display device shown in FIG. 1.

FIG. 6A is a diagram showing an example of a scan image including the image of a finger.

FIG. 6B is a diagram showing an example of a scan image including the image of a finger and the reflected image of the pad of the finger.

FIG. 7 is a flowchart showing the operations of the mode control unit in the liquid crystal display device shown in FIG. 1.

### DETAILED DESCRIPTION OF EMBODIMENTS

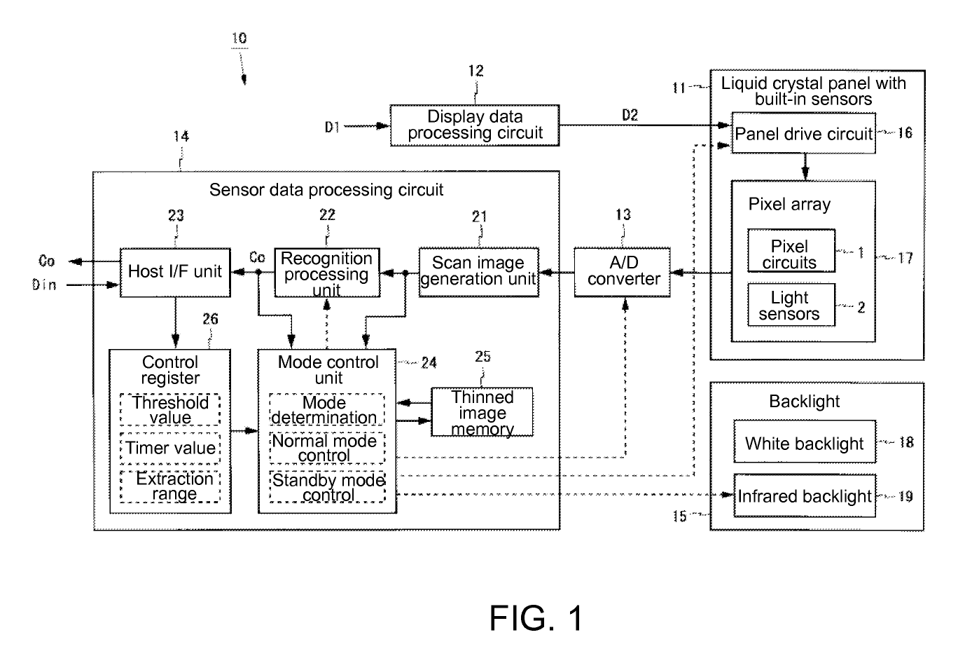

FIG. 1 is a block diagram showing the configuration of a liquid crystal display device according to an embodiment of the present invention. A liquid crystal display device 10 shown in FIG. 1 is equipped with a liquid crystal panel with built-in sensors 11 (hereinafter simply referred to as a liquid crystal panel), a display data processing circuit 12, an A/D converter 13, a sensor data processing circuit 14, and a backlight 15. The liquid crystal panel 11 includes a panel drive circuit 16 and a pixel array 17. In the pixel array 17, a plurality of pixel circuits 1 and a plurality of light sensors 2 are formed two dimensionally.

Display data D1 is input to the liquid crystal display device 10 from outside. The display data processing circuit 12 performs color correction processing, frame rate conversion processing or the like on the display data D1 as necessary, and outputs display data D2. The panel drive circuit 16 writes a voltage in accordance with the display data D2 to the pixel circuits 1. As a result, an image based on the display data D2 is displayed in the liquid crystal panel 11.

The backlight 15 emits light (backlight light) onto a back surface of the liquid crystal panel 11 based on a power supply voltage supplied from a backlight power supply circuit (not shown in the figure). The backlight 15 includes a white backlight 18 that emits white light, and an infrared backlight 19 that emits infrared light. The white backlight 18 is formed for displaying images, and the infrared backlight 19 is formed for detecting a contact position.

In addition to the operation of writing a voltage to the pixel circuits 1, the panel drive circuit 16 performs the operation of reading a voltage corresponding to the amount of received light from the light sensors 2. An output signal (hereinafter referred to as a sensor output signal) of the light sensors 2 is output to the outside of the liquid crystal panel 11. The A/D converter 13 converts the analog sensor output signal to a digital signal.

The sensor data processing circuit 14 includes a scan image generation unit 21, a recognition processing unit 22, a host interface unit 23 (hereinafter referred to as a host I/F unit), a mode control unit 24, a thinned image memory 25, and a control register 26. The scan image generation unit 21 generates a digital image (hereinafter referred to as a scan image) based on a digital signal output from the A/D converter 13. This scan image may include an image of an object (a finger, a pen or the like, for example; hereinafter referred to as a target object) detected that is located in the vicinity of a surface of the liquid crystal panel 11. The recognition processing unit 22 performs a recognition processing on the scan image for detecting the target object, finds the position of the target object within the scan image, and outputs coordinate data Co indicating the contact position. The coordinate data Co that has been output from the recognition processing unit 22 is output to a host (not shown in the figure) through the host I/F unit 23.

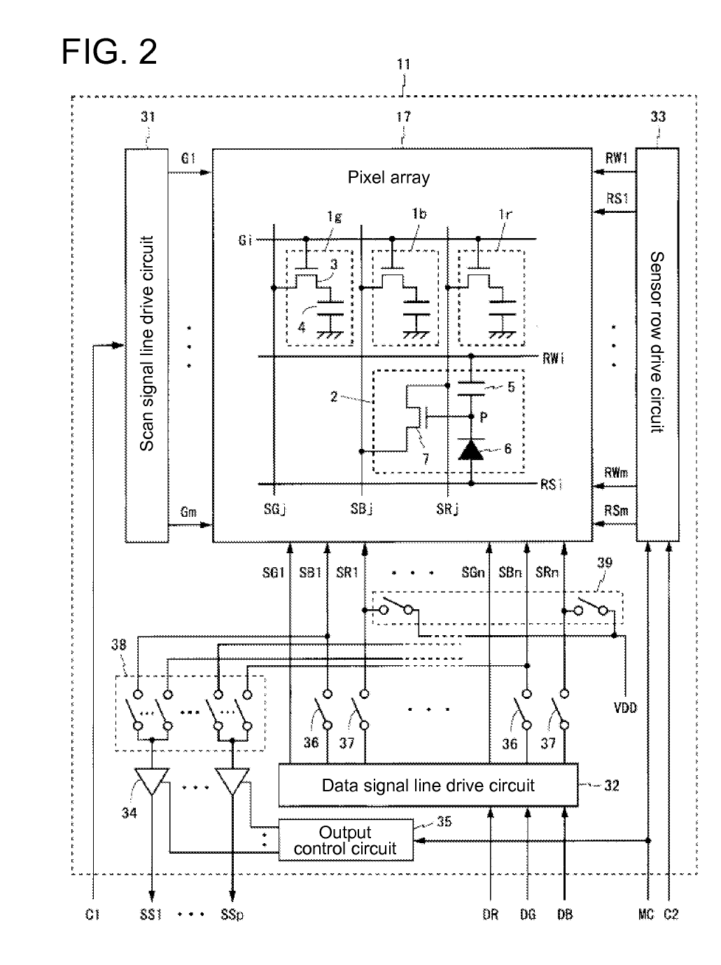

FIG. 2 is a block diagram showing the detailed configuration of the liquid crystal panel 11. As shown in FIG. 2, the pixel array 17 is equipped with m number of scan signal lines G1 to Gm, 3n number of data signal lines SR1 to SRn, SG1 to SGn, and SB1 to SBn, and (m×3n) number of pixel circuits 1. In addition to these, the pixel array 17 is equipped with (m×n) number of light sensors 2, m number of sensor read-out lines RW1 to RWm, and m number of sensor reset lines RS1 to RSm. The liquid crystal panel 11 is formed using polycrystalline silicon, for example.

The scan signal lines G1 to Gm are arranged in parallel with each other. The data signal lines SR1 to SRn, SG1 to SGn, and SB1 to SBn are arranged in parallel with each other such that they are perpendicular to the scan signal lines G1 to Gm. The sensor read-out lines RW1 to RWm and the sensor reset lines RS1 to RSm are arranged so as to be parallel with the scan signal lines G1 to Gm.

Each of the pixel circuits 1 is formed in the vicinity of the respective intersections between the scan signal lines G1 to Gm and the data signal lines SR1 to SRn, SG1 to SGn, and SB1 to SBn. The pixel circuits 1 are arranged two dimensionally as a whole such that m number of pixel circuits 1 are arranged in the column direction (vertical direction in FIG. 2), and that 3n number of pixel circuits 1 are arranged in the row direction (horizontal direction in FIG. 2). The pixel circuits 1 are categorized into an R pixel circuit 1r, a G pixel circuit 1g, and a B pixel circuit 1b based on which color of color filter is formed. These three kinds of pixel circuits are arranged in the row direction in the order of G, B, and R, and a pixel is formed of the three pixel circuits.

A pixel circuit 1 includes a TFT (Thin Film Transistor) 3 and a liquid crystal capacitance 4. The gate terminal of a TFT 3 is connected to a scan signal line G1 (i is an integer equal to or more than 1 and equal to or less than m), the source terminal is connected to any one of data signal lines SRj, SGj, and SBj (j is an integer equal to or more than 1 and equal to or less than n), and the drain terminal is connected to one of the electrodes of the liquid crystal capacitance 4. A common electrode voltage is applied to the other electrode of the liquid crystal capacitance 4. Hereinafter, data signal lines SR1 to SRn connected to an R pixel circuit 1r are called R data signal lines, data signal lines SB1 to SBn connected to a B pixel circuit 1b are called B data signal lines. Here, a pixel circuit 1 may include an auxiliary capacitance.

The light transmittance of a pixel circuit 1 (luminance of sub pixels) is determined by a voltage written in the pixel circuit 1. In order to write a certain voltage to a pixel circuit 1 that is connected to a scan signal line G1 and a data signal line SXj (X is any one of R, G, and B), a high level voltage (voltage to turn on a TFT 3) is applied to the scan signal line G1 and a voltage to be written is applied to the data signal line SXj. It is possible to set the luminance of sub pixels to a desired level by writing a voltage according to the display data D2 in the pixel circuits 1.

A light sensor 2 includes a capacitor 5, a photodiode 6, and a sensor preamplifier 7, and is formed for each pixel. One of the electrodes of the capacitor 5 is connected to a cathode terminal of the photodiode 6 (hereinafter, this connection point is referred to as a node P). The other electrode of the capacitor 5 is connected to a sensor read-out line RWi, and an anode terminal of the photo diode 6 is connected to a sensor reset line RSi. A sensor preamplifier 7 is constituted of a TFT in which the gate terminal is connected to the node P, the drain terminal is connected to an R data signal line SRj, and the source terminal is connected to a B data signal line SBj.

In order to detect the amount of light by a light sensor 2 that is connected to the sensor read-out line RWi, the B data signal line SBj or the like, prescribed voltages are applied to the sensor read-out line RWi and the sensor reset line RSi, and a power supply voltage VDD is applied to the R data signal line SRj. When light enters a photo diode 6 after prescribed voltages were applied to the sensor read-out line RWi and the sensor reset line RSi, a current corresponding to the amount of the incident light flows into the photo diode 6, and a voltage of the node P is lowered by the amount of the current flowed in. When a high voltage is applied to the sensor read-out line RWi at this timing to raise the voltage of the node P, and a power supply voltage VDD is applied to the R data signal line SRj after a gate voltage of the sensor preamplifier 7 was raised to equal to or more than a threshold value, the voltage of the node P is amplified by the sensor preamplifier 7, and a voltage after the amplification is output to the B data signal line SBj. Therefore, it is possible to find the amount of light detected by the light sensors 2 based on the voltage of the B data signal line SBj.

Formed around the pixel array 17 are a scan signal line drive circuit 31, a data signal line drive circuit 32, a sensor row drive circuit 33, p number (p is an integer equal to or more than 1 and equal to or less than n) of sensor output amplifiers 34, an output control circuit 35, and a plurality of switches 36 to 39. These circuits correspond to the panel drive circuit 16 in FIG. 1.

The data signal line drive circuit 32 has 3n number of output terminals corresponding to 3n number of data signal lines. The switches 36 are respectively disposed between the B data signal lines SB1 to SBn and the corresponding n number of output terminals, and the switches 37 are respectively disposed between the R data signal lines SR1 to SRn and the corresponding n number of output terminals. The B data signal lines SB1 to SBn are divided into a group of p number of lines, and each of the switches 38 is disposed between the k-th (k is an integer equal to or more than 1 and equal to or less than p) B data signal line in the group and an input terminal of the k-th sensor output amplifier 34. Each of the switches 39 is disposed between the respective R data signal line SR1 to SRn and the power supply voltage VDD. The number of the switches 36 to 39 included in FIG. 2 is respectively “n”.

In the liquid crystal display device 10, one frame time is divided into a display period in which a signal (voltage signal according to display data) is written in pixel circuits, and a sensing period in which a signal (voltage signal corresponding to the amount of received light) is read from light sensors, and the circuits shown in FIG. 2 performs different operations in the display period and the sensing period. In the display period, the switches 36 and 37 are in an ON-state, and the switches 38 and 39 are in the OFF-state. On the other hand, in the sensing period, the switches 36 and 37 become an OFF-state, the switch 39 becomes an ON-state, and the switch 38 becomes an ON-state on a time division basis so that the B data signal lines SB1 to SBn are sequentially connected to the input terminals of the sensor output amplifiers 34 group by group.

In the display period, the scan signal line drive circuit 31 and the data signal line drive circuit 32 are operated. The scan signal line drive circuit 31 selects one scan signal line from the scan signal lines G1 to Gm according to a timing control signal C1 for each line time, and applies a high-level voltage to the selected scan signal line, and applies a low-level voltage to the remaining scan signal lines. The data signal line drive circuit 32 drives the data signal lines SR1 to SRn, SG1 to SGn, and SB1 to SBn in a line-by-line sequential method based on display data DR, DG and DB that have been output from the display data processing circuit 12. More specifically, the data signal line drive circuit 32 stores at least one line of the respective display data DR, DG, and DB, and applies voltages in accordance with the display data of one line to the data signal lines SR1 to SRn, SG1 to SGn, and SB1 to SBn for each line time. Further, the data signal line drive circuit 32 may drive the data signal lines SR1 to SRn, SG1 to SGn, and SB1 to SBn by a point-to-point method.

In the sensing period, the sensor row drive circuit 33, the sensor output amplifiers 34, and the output control circuit 35 are operated. The sensor row drive circuit 33 selects one signal line from the sensor read-out lines RW1 to RWm and one signal line from the sensor reset lines RS1 to RSm during each line time according to the timing control signal C2, and a prescribed read-out voltage and a prescribed reset voltage are applied to the selected sensor read-out line and the sensor reset line, and voltages that are different from the voltages applied when selected are applied to the other signal lines. Further, the length of the one line time is typically different for the display period and the sensing period. The sensor output amplifiers 34 amplify a voltage selected by a switch 38, and outputs it as sensor output signals SS1 to SSp. The operation of the output control circuit 35 will be described later.

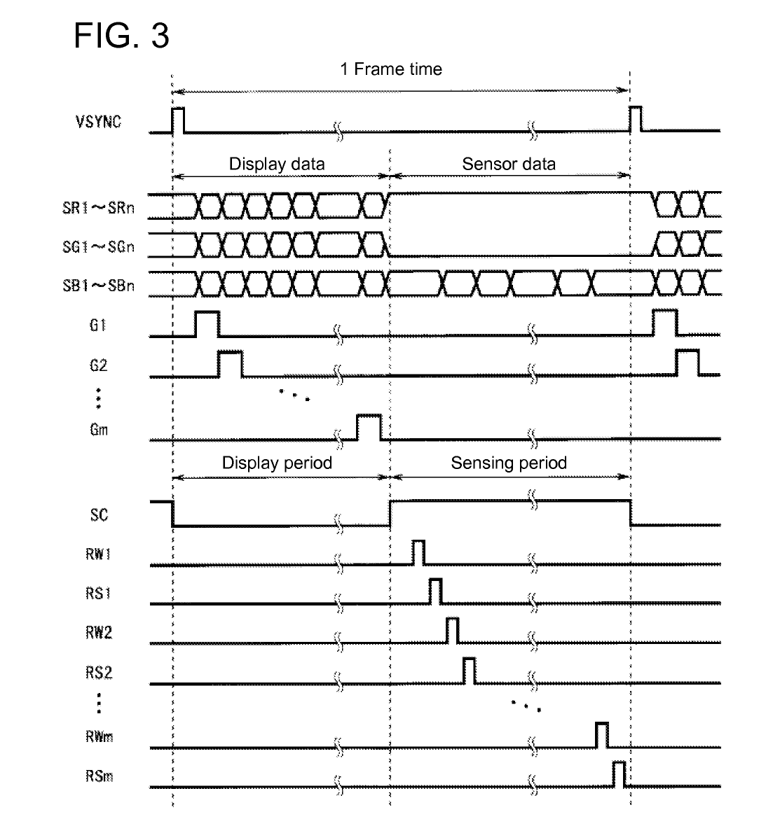

FIG. 3 is a timing chart of the liquid crystal display device 10. As shown in FIG. 3, a vertical synchronizing signal VSYNC becomes a high-level for each frame time, and one frame time is divided into a display period and a sensing period. A sensing signal SC is a signal indicating the display period or the sensing period, and becomes a low-level in the display period and a high-level in the sensing period.

In the display period, the switches 36 and 37 become an ON-state, and all of the data signal lines SR1 to SRn, SG1 to SGn, and SB1 to SBn are connected to the data signal line drive circuit 32. In the display period, first, a voltage of the scan signal line G1 becomes a high-level, and next, a voltage of the scan signal line G2 becomes a high-level, and after that, a voltage of the scan signal lines G3 to Gm becomes a high-level in sequence. While the voltage of the scan signal line G1 is at a high-level, the data signal lines SR1 to SRn, SG1 to SGn, and SB1 to SBn are applied with voltages that are to be written in the 3n number of pixel circuits 1 connected to the scan signal line G1.

In the sensing period, the switch 39 becomes an ON-state, and the switch 38 becomes an ON-state on a time division basis. Therefore, a power supply voltage VDD is applied to the R data signal lines SR1 to SRn on a fixed basis, and the B data signal lines SB1 to SBn are connected to the input terminals of the sensor output amplifier 34 on a time division basis. In the sensing period, a sensor read-out line RW1 and a sensor reset line RS1 are selected first, and a sensor read-out line RW2 and a sensor reset line RS2 are selected next, and after that, sensor read-out lines RW3 to RWm and sensor reset lines RS3 to RSm are sequentially selected one pair at a time. A read-out voltage and a reset voltage are applied to the selected sensor read-out line and sensor reset line, respectively. While the sensor read-out line RWi and the sensor reset line RSi are selected, a voltage according to the amount of light detected by each of n number of light sensors 2, which are connected to the sensor read-out line RWi, is output to the corresponding B data signal line SB1 to SBn. Moreover, in the standby mode, which will be described later, only some of the signal lines among the sensor read-out lines RW1 to RWm and the sensor reset lines RS1 to RSm are sequentially selected one pair at a time.

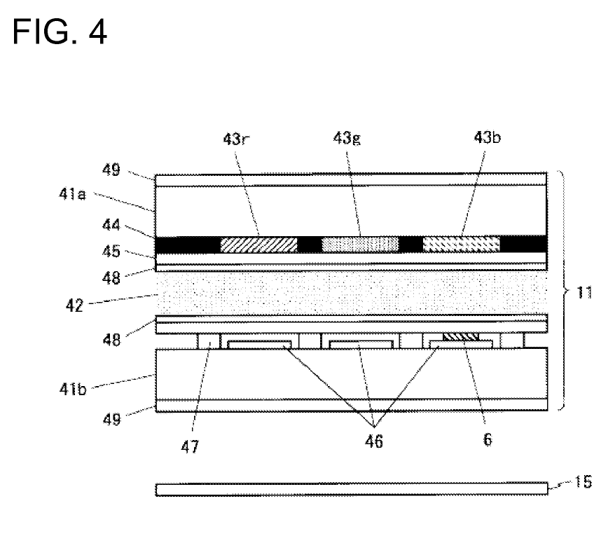

FIG. 4 is a diagram showing a cross-section of the liquid crystal panel 11 and the arrangement position of the backlight 15. The liquid crystal panel 11 has a configuration in which a liquid crystal layer 42 is interposed between two glass substrates 41a and 41b. Formed in one glass substrate 41a are three different color filters 43r, 43g, and 43b, a light-shielding film 44, an opposite electrode 45 and the like, and formed in the other glass substrate 41b are pixel electrodes 46, a data signal line 47, light sensors 2 and the like. In FIG. 4, a photo diode 6 included in a light sensor 2 is formed in the vicinity of a pixel electrode 46 where a blue color filter 43b is formed. An alignment film 48 is formed on the glass substrates 41a and 41b in the surfaces facing each other, and a polarizing plate 49 is formed on the other surfaces. Among the two surfaces of the liquid crystal panel 11, a surface on the side of the glass substrate 41a becomes a front-surface, and a surface on the side of the glass substrate 41b becomes a rear-surface.

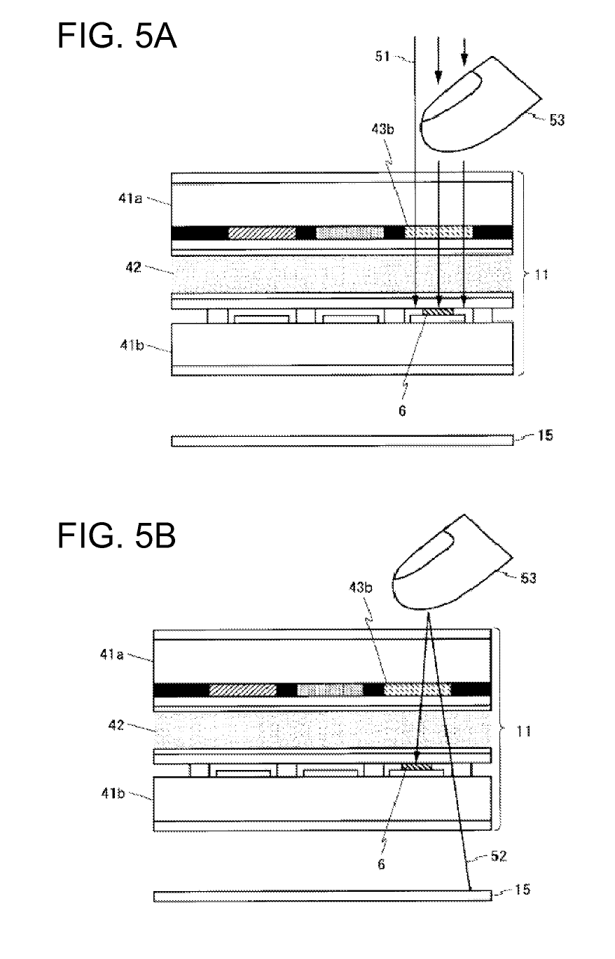

The liquid crystal display device 10 uses either a method of detecting a silhouette or a method of detecting a reflected image (or both an image and a reflected image) in detecting the contact position on the display screen. FIG. 5A is a diagram showing the principle of a method of detecting a silhouette, and FIG. 5B is a diagram showing the principle of a method of detecting a reflected image. In the method of detecting an image (FIG. 5A), a light sensor 2 including a photo diode 6 detects external light 51 transmitted through the glass substrate 41a, the liquid crystal layer 42 and the like. Here, if a target object 53 such as a finger is in the vicinity of the front surface of the liquid crystal panel 11, the external light 51 that is to enter the light sensor 2 is blocked by the target object 53. Therefore, it is possible to detect the silhouette of the target object 53 created by the external light 51 using the light sensor 2.

In the method of detecting a reflected image (FIG. 5B), a light sensor 2 including a photo diode 6 detects a reflected light of a backlight light 52. More specifically, a backlight light 52 emitted from the backlight 15 transmits through the liquid crystal panel 11, and exits to outside from the front surface of the liquid crystal panel 11. Here, if a target object 53 is located in the vicinity of the front surface of the liquid crystal panel 11, the backlight light 52 is reflected by the target object 53. For example, the pad of a human finger reflects light well. The reflected light of the backlight light 52 transmits through the glass substrate 41a, the liquid crystal layer 42 and the like, and enters the light sensor 2. Accordingly, it is possible to detect the reflected image of the target object 53 created by the backlight light 52 using the light sensor 2.

Further, both a silhouette and a reflected image can be detected by using the above-mentioned two methods concurrently. That is, using the light sensor 2, it is possible to detect a silhouette of the target object 53 created by the external light 51 and a reflected image of the target object 53 created by the backlight light 52 at the same time.

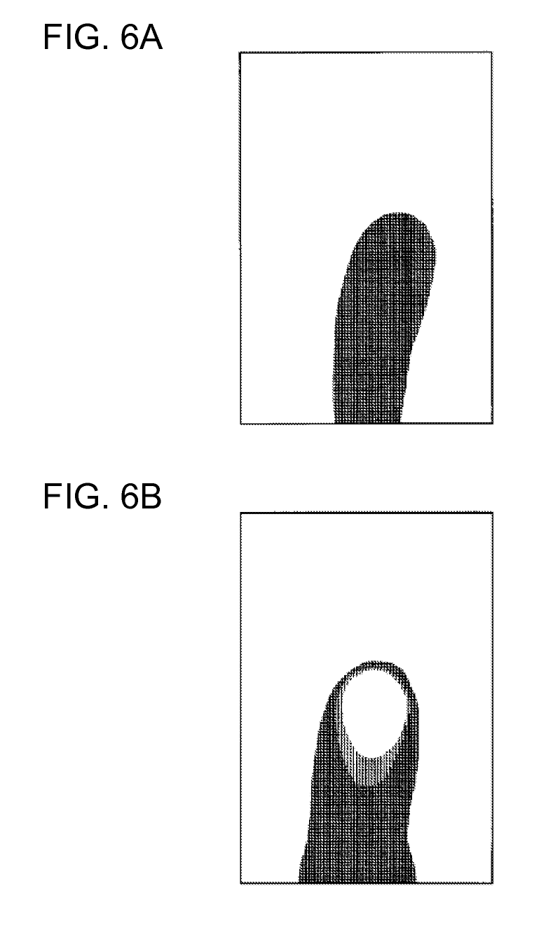

FIGS. 6A and 6B are diagrams showing examples of a scan image including an image of a finger. A scan image shown in FIG. 6A includes a silhouette of a finger, and a scan image shown in FIG. 6B includes a silhouette of a finger and a reflected image of the pad of the finger. The sensor data processing circuit 14 performs an image recognition processing on such scan images, and outputs coordinate data Co indicating the contact position.

Switching of operation modes in the liquid crystal display device 10 will be described below. The liquid crystal display device 10 has a normal mode and a standby mode in order to reduce the power consumption, and the operation of circuits stops or the operation speed of circuits becomes slow in the standby mode. Specifically, in the normal mode, the panel drive circuit 16 reads signals from all light sensors 2, the A/D converter 13 converts all the sensor output signals to digital values, the recognition processing unit 22 performs a recognition processing, and the infrared backlight 19 is turned on. On the other hand, in the standby mode, the panel drive circuit 16 reads signals from some of the light sensors 2, the A/D converter 13 converts the some of the sensor output signals to digital values, the recognition processing unit 22 stops the operation, and the infrared backlight 19 turns off the light.

In order to perform the above-mentioned mode control, the sensor data processing circuit 14 includes a mode control unit 24, a thinned image memory 25, and a control register 26. The mode control unit 24 performs a mode determination processing to determine whether in the normal mode or in the standby mode, and performs a normal mode control processing in which the operation of circuits is controlled in the normal mode and a standby mode control processing in which the operation of circuits is controlled in the standby mode. The thinned image memory 25 functions as an image storing unit that stores a comparison target image based on signals read from light sensors 2 when the normal mode is switched to the standby mode.

The control register 26 stores various parameters that are necessary for the operation of the mode control unit 24. Specifically, the control register 26 stores a first threshold value TH1, a second threshold value TH2, a first timer value TM1, a second timer value TM2, an extraction range ER and the like. The two threshold values TH1 and TH2, and the two timer values TM1 and TM2 are used for the mode determination processing, and the extraction range ER is used for the standby mode control processing. Parameters to be stored in the control register 26 are set from a host through the host I/F unit 23.

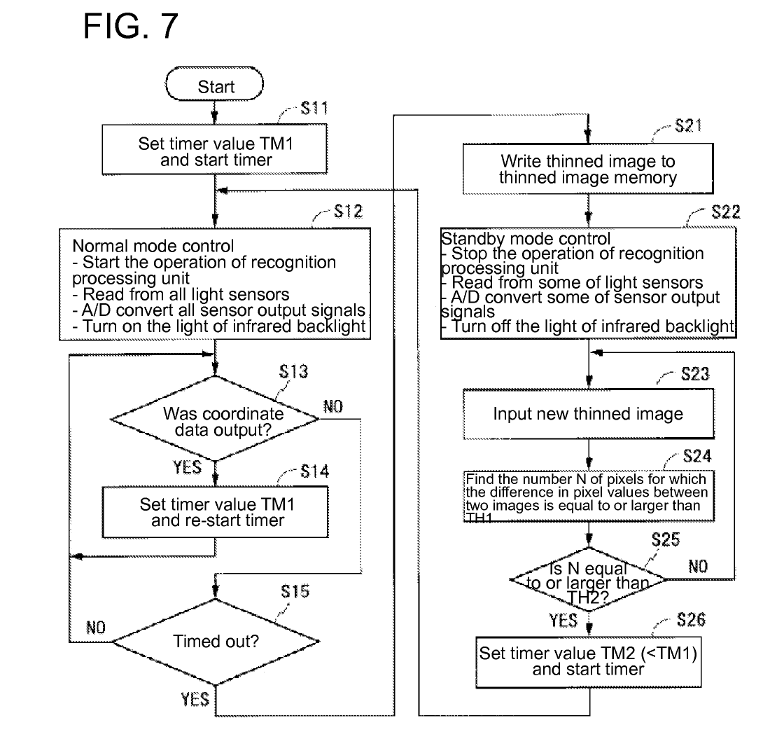

FIG. 7 is a flow chart showing the operation of the mode control unit 24. First, the mode control unit 24 sets a first timer value TM1 stored in the control register 26 to start a timer (Step S11). Next, the mode control unit 24 performs the normal mode control processing (Step S12). In Step S12, based on a control signal (signal shown with dashed lines in FIG. 1) output from the mode control unit 24, the recognition processing unit 22 starts its operation, the panel drive circuit 16 reads signals from all light sensors 2, the A/D converter 13 converts all sensor output signals to digital values, and the infrared backlight 19 is turned on.

Next, the mode control unit 24 checks whether or not coordinate data Co have been output from the recognition processing unit 22 (Step S13). The mode control unit 24 proceeds to Step S14 when coordinate data Co have been output, and proceeds to Step S15 when no coordinate data Co has been output. In the former case, the mode control unit 24 sets a first timer value TM1 stored in the control register 26 to re-start the timer (Step S14), and proceeds to Step S13. In the latter case, the mode control unit 24 checks whether or not the timer has timed-out (Step S15). When the timer has not timed-out, the mode control unit 24 proceeds to Step S13. When the timer has timed-out, the mode control unit 24 proceeds to Step S21 to switch the normal mode to the standby mode.

When the normal mode is switched to the standby mode, the mode control unit 24 generates an image in which pixel values are partially extracted from a scan image (hereinafter referred to as a thinned image), and writes the thinned image in the thinned image memory 25 (Step S21). Next, the mode control unit 24 performs the standby mode control processing (Step S22). In Step S22, based on a control signal output from the mode control unit 24, the recognition processing unit 22 stops its operation, the panel drive circuit 16 reads signals from only some of the light sensors 2, the A/D converter 13 converts the some of the sensor output signals to digital values, and the infrared backlight 19 turns off its light.

More specifically, a mode control signal indicating the normal mode or the standby mode is included in the control signal that is output from the mode control unit 24. As shown in FIG. 2, a mode control signal MC supplied to the liquid crystal panel 11 is input to the sensor row drive circuit 33 and the output control circuit 35. During the sensing period in the standby mode, the sensor row drive circuit 33 sequentially selects only some of the signal lines, one pair at a time, from the sensor read-out lines RW1 to RWm and the sensor reset lines RS1 to RSm. Here, the output control circuit 35 controls the sensor output amplifiers 34 so that sensor output signals SS1 to SSp are output from only some of the sensor output amplifiers 34. Further, the A/D converter 13 converts signals read from the some of the light sensors 2 to digital signals.

The mode control unit 24 may output a control signal indicating a processing range based on the extraction range ER stored in the control register 26 in Step S22. For example, when the extraction range ER stored in the control register 26 shows the bottom half of the display screen, the mode control unit 24 outputs to the panel drive circuit 16 and the A/D converter 13 a control signal indicating that the bottom half of the display screen should be processed. Based on this control signal, the panel drive circuit 16 reads signals from light sensors 2 disposed in the bottom half of the pixel array 17. The A/D converter 13 converts the signals read from the light sensors 2 to digital signals.

As just described, according to the result determined by the mode control unit 24, in the standby mode, the panel drive circuit 16 reads from light sensors 2 the amount of signals smaller than when in the normal mode. Moreover, according to the result determined by the mode control unit 24, the A/D converter 13 performs a conversion to digital values less frequently in the standby mode than in the normal mode. As a result, in the standby mode, the scan image generation unit 21 repeatedly outputs a thinned image generated by partially extracting pixel values from a scan image that would be output in the normal mode. Here, the thinned image that is output in the standby mode is based on signals read from light sensors 2, and is same as the thinned image generated in Step S21.

Next, a new thinned image output from the scan image generation unit 21 is input to the mode control unit 24 (Step S23). Next, the mode control unit 24 compares pixel by pixel the thinned image stored in the thinned image memory 25 with the new thinned image, which has been input in Step S23, and finds the number N of pixels for which a difference in pixel values is equal to or larger than the first threshold value TH1, which has been stored in the control register 26 (Step S24). Next, the mode control unit 24 compares the number N found in Step S24 with the second threshold value TH2 stored in the control register 26 (Step S25). The mode control unit 24 proceeds to Step S26 when N2 is equal to or larger than TH2, and proceeds to Step S23 when N2 is smaller than TH2. In the former case, the mode control unit 24 sets the second timer value TM2 stored in the control register 26 to start the timer (Step S26), and proceeds to Step S12 to switch the standby mode to the normal mode. Here, the second timer value TM2 is smaller than the first timer value TM1.

As just described, the mode control unit 24 causes the normal mode to be switched to the standby mode when a state that no coordinate data Co is output continues for a prescribed time period (when the time passes the first timer value TM1). Further, the mode control unit 24 causes a switch from the standby mode to the normal mode when the newly supplied thinned image changes from the thinned image stored in the thinned image memory 25 (the thinned image stored when the normal mode was switched to the standby mode) by a prescribed amount or more. Moreover, immediately after the standby mode is switched to the normal mode, the mode control unit 24 switches the normal mode to the standby mode when a state that no coordinate data Co is output continues for a shorter period of time (when the time passes the second timer value TM2) compared to when it has continuously been in the normal mode.

Effects of the liquid crystal display device 10 of the present embodiment will be described below. The liquid crystal display device 10 of the present embodiment is equipped with a liquid crystal panel with built-in sensors 11, a panel drive circuit 16, a recognition processing unit 22, a mode control unit 24, and a thinned image memory 25. The mode control unit 24 determines the normal mode or the standby mode, and operates the recognition processing unit 22 in the normal mode, and stops the operation of the recognition processing unit 22 in the standby mode. The thinned image memory 25 stores a thinned image when the normal mode is switched to the standby mode, and the mode control unit 24 switches the standby mode to the normal mode when a newly supplied thinned image changes from the thinned image stored in the thinned image memory 25 by a prescribed amount or more. Particularly, the mode control unit 24 compares the thinned image stored in the thinned image memory 25 with the newly supplied thinned image pixel by pixel, and switches the standby mode to the normal mode when the number of pixels for which a difference in pixel values is equal to or larger than the first threshold value TH1 is equal to or exceeds the second threshold value TH2.

As just described, whether in the normal mode or in the standby mode is determined and the operation of the recognition processing unit 22 is stopped in the standby mode, and therefore, it is possible to reduce the power consumption of the liquid crystal display device 10. Further, because the normal mode is resumed when a thinned image changes by a prescribed amount or more since the switch to the standby mode was made, it is possible to resume the normal mode before a target object comes in contact with the screen. Thus, it is possible to rapidly leave the standby mode and quickly detect the contact position.

Moreover, the two threshold values TH1 and TH2 are stored in the control register 26 that is capable of setting values from outside. Therefore, the conditions for a mode determination processing can be adjusted according to a usage mode or the like, and a suitable mode determination processing becomes possible.

Further, the mode control unit 24 switches the normal mode to the standby mode when a state that no coordinate data Co is output continues for a prescribed time period. This way, it is possible to reduce the power consumption of the liquid crystal display device 10 by switching to the standby mode and stopping the recognition processing unit 22 when no recognition processing is necessary. Particularly, immediately after the standby mode is switched to the normal mode, the mode control unit 24 switches the normal mode to the standby mode when a state that no coordinate data Co is output continues for a shorter period of time compared to when it has continuously been in the normal mode. Thus, when the resumed recognition processing is not actually needed, the standby mode is resumed in a short period of time and the recognition processing unit 22 is stopped so that the power consumption of the liquid crystal display device 10 can be reduced more effectively.

The thinned image has a smaller number of pixels than a scan image. Because such a thinned image is used to perform the mode determination processing, it is possible to reduce the amount of memory and the amount of computing necessary for the mode determination processing. Furthermore, a thinned image is an image in which pixel values are partially extracted from a scan image. Such a thinned image can be easily generated without performing an average value computation processing or the like. Moreover, the extraction range of a thinned image is stored in the control register 26 that is capable of setting values from outside. This way, it is possible to extract the thinned image from a preferable position in accordance with a usage mode or the like, and to perform a suitable mode determination processing.

Further, according to the result determined by the mode control unit 24, the panel drive circuit 16 reads from light sensors 2 the smaller amount of signals in the standby mode than in the normal mode, and the A/D converter 13 performs a conversion to digital values less frequently in the standby mode than in the normal mode. Because the operation speed of the panel drive circuit 16 and the A/D converter 13 is slowed down in the standby mode as just described, it is possible to reduce the power consumption of the liquid crystal display device 10 while generating thinned images necessary for the mode determination processing. The mode control unit 24 also turns off the light of the infrared backlight 19 in the standby mode. Accordingly, it is possible to reduce the power consumption of the liquid crystal display device 10.

Furthermore, various modification examples can be configured for the liquid crystal display device of the present embodiment. For example, the liquid crystal display device of the present invention may include the function of switching from the normal mode to the standby mode (or vise-versa) according to a signal input from a host. Moreover, as for the thinned image stored in the thinned image memory 25, the image may be an image generated at the end of the normal mode or an image generated at the beginning of the standby mode as long it is an image stored when the normal mode is switched to the standby mode. It is also not necessary for all the above-mentioned parameters to be stored in the control register 26; all or some of these parameters may be fixed values. For example, only one of the two threshold values TH1 and TH2 may be stored in the control register 26, and the other threshold value may be a fixed value. Moreover, the extraction range ER may be fixed to coincide with the entire display screen at all times.

As described above, the display device of the present invention is capable of rapidly leaving the standby mode and quickly detecting the contact position when necessary while stopping the operation of circuits and slowing down the operation speed of circuits in the standby mode to reduce the power consumption.

### INDUSTRIAL APPLICABILITY

The display device of the present invention has an effect of being able to leave the standby mode and quickly detect the contact position, and therefore, it can be used for various display devices equipped with a plurality of light sensors such as a liquid crystal display device with light sensors.

### DESCRIPTION OF REFERENCE CHARACTERS

1 . . . Pixel circuit
2 . . . Light sensor
10 . . . Liquid crystal display device
11 . . . Liquid crystal panel with built-in sensors
12 . . . Display data processing circuit
13 . . . A/D converter
14 . . . Sensor data processing circuit
15 . . . Backlight
16 . . . Panel drive circuit
17 . . . Pixel array
18 . . . White backlight
19 . . . Infrared backlight
21 . . . Scan image generation unit
22 . . . Recognition processing unit
23 . . . Host I/F unit
24 . . . Mode control unit
25 . . . Thinned image memory
26 . . . Control register

1. A display device equipped with a plurality of light sensors, comprising:
a display panel including a plurality of pixel circuits and a plurality of light sensors arranged two dimensionally;
a drive circuit that performs an operation of writing a signal in accordance with display data to said pixel circuits, and performs an operation of reading a signal that corresponds to an amount of received light from said light sensors;
a recognition processing unit that performs a recognition processing on a recognition target image that is generated based on the signal read from said light sensors, and outputs coordinate data indicating a position of an object of detection;
a mode control unit that determines a normal mode or a standby mode, the mode control unit causing said recognition processing unit to operate in the normal mode, and causing said recognition processing unit to cease operating in the standby mode; and
an image storing unit that stores a comparison target image that is generated based on a signal read from said light sensors when the normal mode is switched to the standby mode,
wherein said mode control unit switches the standby mode to the normal mode when a newly supplied comparison target image changes from the comparison target image stored in said image storing unit by a prescribed amount or more.

2. The display device according to claim 1, wherein said mode control unit compares the comparison target image stored in said image storing unit with the newly supplied comparison target image pixel by pixel, and switches the standby mode to the normal mode when the number of pixels at which a difference in pixel value is equal to or greater than a first threshold value is equal to or exceeds a second threshold value.

3. The display device according to claim 2, wherein at least one of said first and second threshold values is stored in a register that is capable of setting the value from outside.

4. The display device according to claim 1, wherein said mode control unit switches the normal mode to the standby mode when a state that said coordinate data is not output continues for a prescribed time period.

5. The display device according to claim 4, wherein, immediately after the standby mode is switched to the normal mode, said mode control unit switches the normal mode to the standby mode when a state that said coordinate data is not output continues for a shorter period of time compared to when the normal mode has been continuously in effect.

6. The display device according to claim 1, wherein said comparison target image includes a smaller number of pixels than said recognition target image.

7. The display device according to claim 6, wherein said comparison target image is an image generated by partially extracting pixel values from said recognition target image.

8. The display device according to claim 7, wherein an extraction range for said comparison target image is stored in a register that is capable of setting a value from outside.

9. The display device according to claim 7, wherein, according to a result determined by said mode control unit, in the standby mode, said drive circuit reads a smaller amount of signals from said light sensors than when in the normal mode.

10. The display device according to claim 7, further comprising:
an A/D converter that converts a signal read from said light sensors to a digital value,
wherein, according to a result determined by said mode control unit, said A/D converter performs a conversion to a digital value less frequently in the standby mode than in the normal mode.

11. The display device according to claim 1, further comprising:
an infrared backlight that emits infrared light,
wherein said mode control unit turns off said infrared backlight in the standby mode.

12. A method of controlling a display device that comprises a display panel including a plurality of pixel circuits and a plurality of light sensors arranged two dimensionally; and a recognition processing unit that performs a recognition processing on a recognition target image based on a signal read from said light sensors, and outputs coordinate data indicating a position of a detection target object, the method comprising:
writing a signal in accordance with display data to said pixel circuits,
reading from said light sensors a signal corresponding to an amount of received light,
determining whether in a normal mode or in a standby mode,
operating said recognition processing unit in the normal mode, and stopping an operation of said recognition processing unit in the standby mode, and
storing a comparison target image based on a signal read from said light sensors when the normal mode is switched to the standby mode,
wherein said step of determining a mode causes the standby mode to be switched to the normal mode when a newly supplied comparison target image changes from the stored comparison target image by a prescribed amount or more.
